(19) United States
(12) Patent Application Publication
(10) Pub. No.: US 2016/0153212 A1
(43) Pub. Date: Jun. 2, 2016

(54) ELECTRONIC LATCH FOR VEHICLE DOORS

(71) Applicant: ADAC Plastics, Inc., Grand Rapids, MI (US)

(72) Inventors: Robert L. Bingle, Grand Rapids, MI (US); Charles Bruce Banter, Northville, MI (US); Marcus E. Merideth, Westland, MI (US); Keith J. Vadas, Caledonia, MI (US)

(21) Appl. No.: 14/956,843

(22) Filed: Dec. 2, 2015

Related U.S. Application Data
(60) Provisional application No. 62/086,448, filed on Dec. 2, 2014.

(51) Int. Cl. E05B 41/00; E05B 81/06; E05B 81/72; E05B 85/24; E05B 85/04

(52) U.S. Cl. CPC E05B 41/00; E05B 85/243; E05B 85/045; E05B 81/72; E05B 81/06

(57) ABSTRACT

An electronic latch assembly secures a vehicle door to a vehicle frame with a striker and a catch assembly. The striker is attached to the vehicle frame. The catch assembly secures the vehicle door to the vehicle frame when the vehicle door is disposed in a closed position. The catch assembly includes a catch pivotally affixed to a mount at a first axis in an orientation enabling engagement and disengagement of the catch with the striker. The catch is pivotable between a latched disposition and an unlatched disposition. An indicator member is cooperably affixed to the mount with the catch. The catch translates movement to the indicator member when the catch pivots around the first pivot axis between the latched disposition and the unlatched disposition. The indicator member includes an indicator for indicating a disposition of the catch between the latched disposition and unlatched disposition.

### PRIOR APPLICATIONS

The present application claims priority to U.S. Provisional Patent Application No. 62/086,448 filed on Dec. 2, 2014, the contents of which are included herein by reference.

### TECHNICAL FIELD

The present application relates generally toward a latch assembly of a vehicle door. More specifically, the present invention relates toward an electronic latch assembly for a vehicle door.

### BACKGROUND

Vehicle doors have historically included a mechanical engagement between a catch affixed to the vehicle door and a striker affixed on a vehicle frame, such as, for example, a B-pillar for a front vehicle door and a C-pillar for a rear vehicle door. A mechanical door handle mechanically actuates the catch to disengage the catch from the striker so that the vehicle door may be opened. Once the mechanical door handle is actuated, the catch remains in an open position until the catch is again engaged with the striker, upon which the catch pivots into interlocking engagement with the striker. Additionally, the catch partially engages the striker in an intermediate or ajar position so that the door remains partially open while the catch prevents the door from fully opening until the mechanical door handle is again actuated. Once the door has been moved to a position, of at least being ajar, a separate mechanical switch, or compressible button provides an electric signal to an indicator disposed at a location where a vehicle occupant is notified one of the vehicle doors is not fully closed.

Mechanically actuated door latch assemblies are rapidly being replaced by electronic door latch assemblies. As such, electrical current is both provided to the latch assembly and the door handle. However, these actuators continue to make use of a compressible button to provide an electronic signal notifying a vehicle occupant a given door is not in the closed position. Therefore, it would be desirable to provide an electronic latch assembly that is self-contained eliminating redundant wiring associated with a compressible button or other mechanism used to notify the vehicle occupant that a given door is not in a closed position.

### SUMMARY

An electric latch assembly for securing a vehicle door to a vehicle frame includes a striker and a catch assembly. The striker is fixedly attached to the vehicle frame, while the catch assembly is fixedly attached to the vehicle door. The catch assembly includes a catch that is pivotally affixed to a mount at a first pivot axis in an orientation enabling engagement and disengagement of the catch with the striker. The catch is pivotable between a latched disposition and an unlatched disposition relative to the striker. An indicator member is affixed to the mount in a cooperable disposition with the catch. The catch translates movement to the indicator member when the catch pivots around the first pivot axis between the latched disposition and the unlatched disposition. The indicator member includes an indicator for indicating a disposition of the latch between the latched disposition and the unlatched disposition relative to the striker.

The electronic latch assembly of the present invention includes both a catch for securing a striker and an indicator member for indicating a disposition of the catch relative to the striker all in a self-contained package. Therefore, the need for an independent wiring to mechanical switch located elsewhere in the door assembly or vehicle frame used to indicate the disposition of the catch is eliminated. A simplified assembly attached to the door provides both the secure engagement between the catch and the striker, and also provides an indicator capable of signaling a vehicle occupant the disposition of the catch relative to the striker.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 shows a perspective view of a passenger vehicle;

FIG. 2 shows a perspective view of a latch assembly of the present invention;

FIG. 3 shows a further perspective view of the latch assembly of the present invention;

FIG. 4 shows an underside perspective view of the catch assembly of the present invention;

FIG. 5 shows a schematic view of the catch assembly and indicator member;

FIG. 6 shows a plan view of the catch assembly and indicator member; and

FIG. 7 show a plan view of a printed circuit board and detector member.

### DETAILED DESCRIPTION

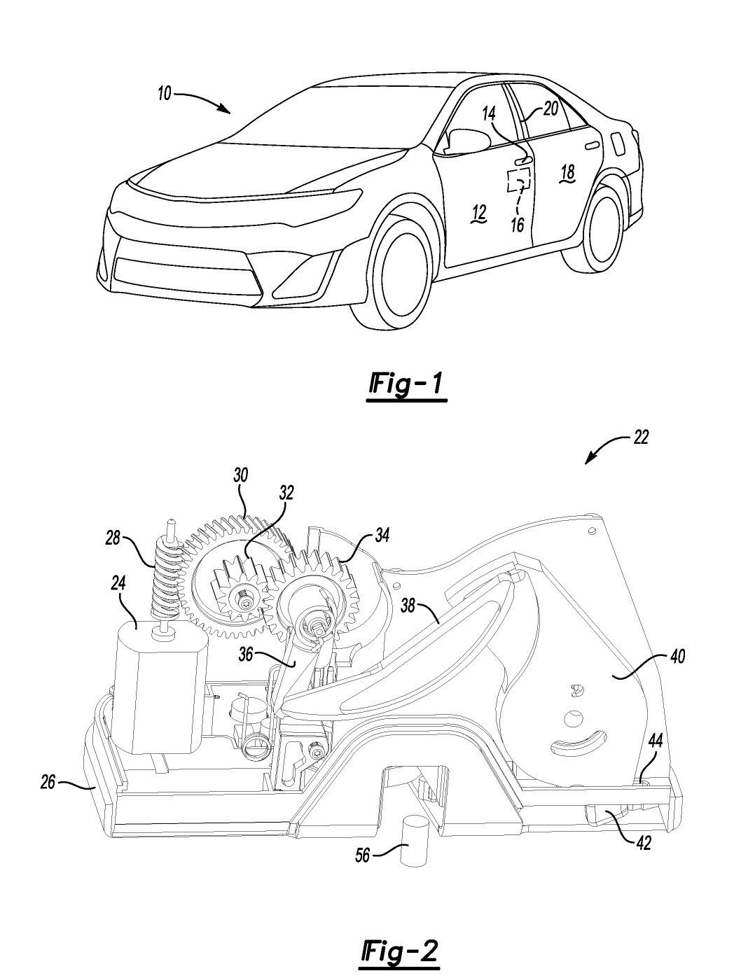

Referring to FIG. 1, a vehicle is generally shown at 10. The vehicle 10 includes a front door 12 and a door handle 14. An electronic latch assembly 16 is shown in phantom on the front door 12 of the vehicle 10, by way of example. However, a rear door 18 of the vehicle 10 also includes a latch assembly 16, although not shown for clarity. Therefore, it should be understood by those of skill in the art that the electronic latch assembly 16 of the present invention is operable on a front door 12, a rear door 18, a deck lid (not shown), tail gate (not shown), or any door of a vehicle requiring secure engagement to a vehicle frame 20 when closed. The latch assembly 16 is disposed in a self-contained module that is easily attached to a door 12, 18 of a motor vehicle 10. A catch assembly generally shown at 22 of FIG. 2 is disposed within a housing (not shown).

The latch assembly 22 includes an electric motor 24 such as, for example, a servo motor that is affixed to a mount 26. The electric motor includes a worm gear 28 that drivably engages a ring gear 30. The ring gear 30 includes a coaxial intermediate gear 32 that drivably engages a drive gear 34. The drive gear 34 translates rotational movement to a coaxial lever 36. Upon rotation of the drive gear 34, the coaxial lever 36 engages a link 38 moving the link 38 in a generally linear direction to translate motion to an intermediate lever 40.

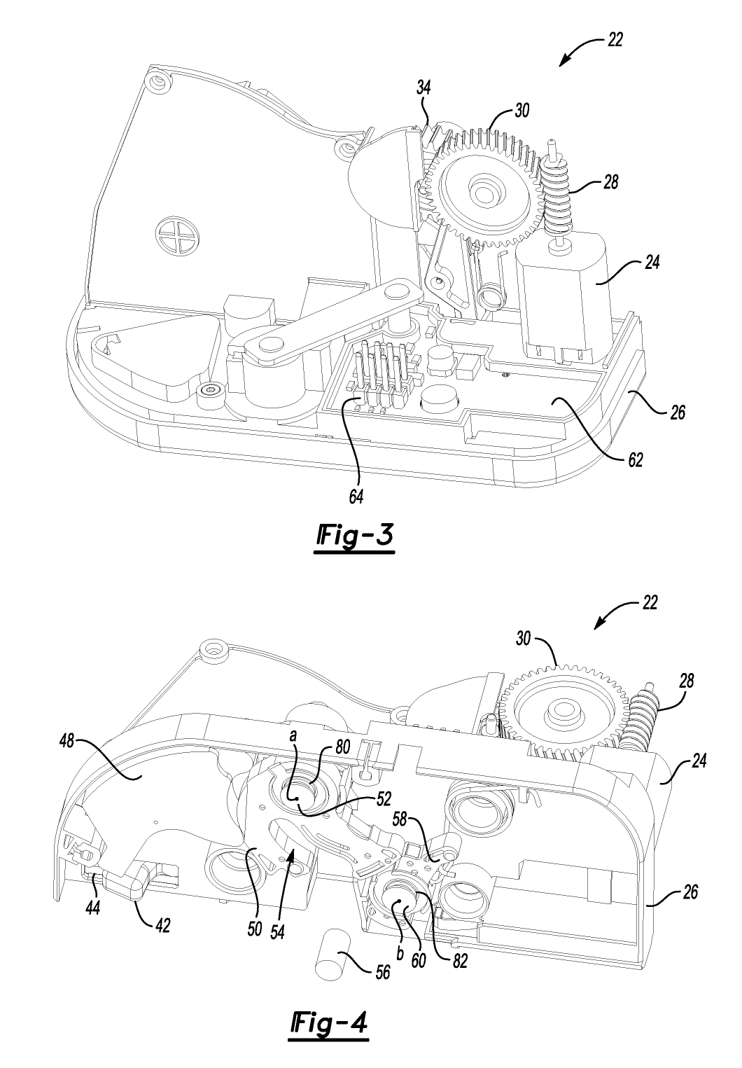

The intermediate lever 40 includes a lever arm 42 that extends through a slot 44 defined by the mount 26. As best seen in FIG. 3, the lever arm 42 abuts an appendage 46 of a release lever 48 that is disposed on an opposite side of the mount 26 from the intermediate lever 40. Each of the gears 28, 30, 32, 32 described above is located on an opposed side of the mount 26 from the release lever 48. The release lever 48 is biased to rotate in a clockwise direction upon the mount 26 when the worm gear 28 translates motion to the intermediate lever 40 causing the lever arm 42 of the intermediate lever 40 to disengage the appendage 46 of the release lever 48.

A catch 50 is pivotally affixed to the mount 26 by a fastener 52 disposed at the first pivot axis a. The catch 50 defines a U-shaped channel 54 configured to receive a striker 56. The striker 56 is fixedly attached to the vehicle frame 20 in a known manner.

An indicator member 58 is pivotally attached to the mount 26 by a second fastener 60 enabling the indicator member 58 to pivot around second axis b. The indicator member 58 is disposed upon the mount 26 at a location that is cooperable with the catch 50 so that the catch 50 translates rotational motion to the indicator member 58 when the catch 50 is caused to pivot around axis a as will be explained further herein below.

A printed circuit board 62 is secured to the mount 26, in part by the second fastener 60 to locate the second pivot axis b in a desirable disposition relative to the indicator member 58. The printed circuit board 62 receives electrical power by way of connector 64 from a vehicle power source (not shown).

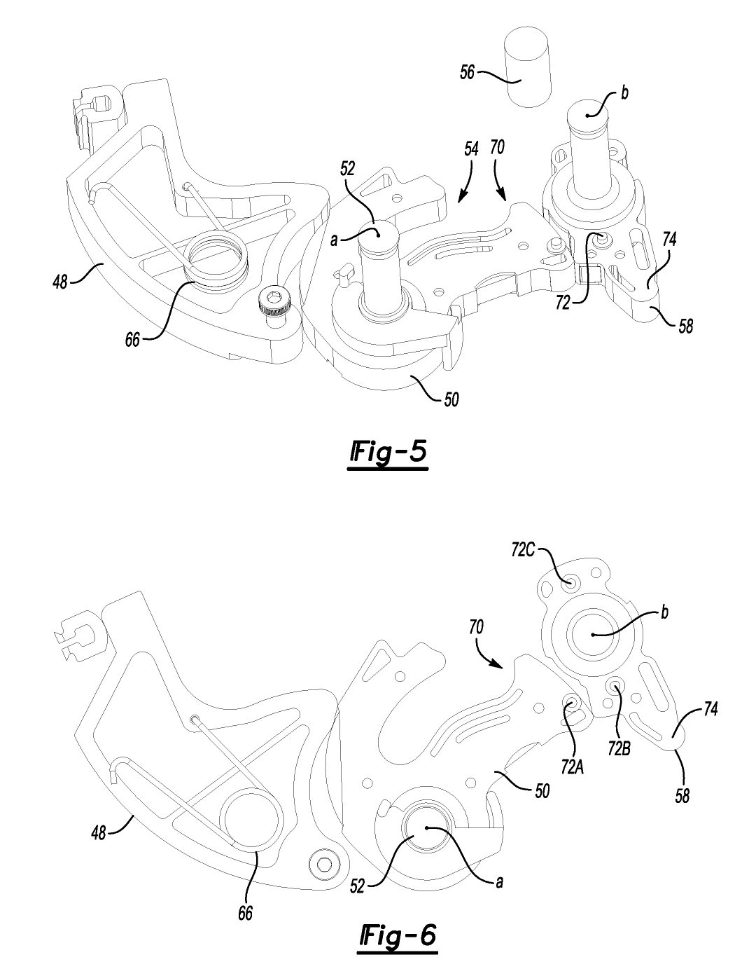

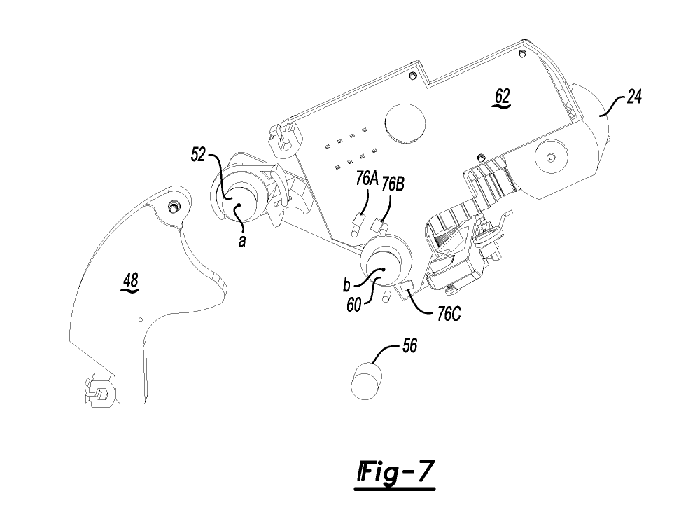

Referring now to FIGS. 5 and 6, a schematic view and a top down view opposite (or mirror image) to that of FIG. 4 is shown. From this view, rotation is explained in the opposite direction as that set forth above. A biasing member 66 biases the release of lever 48 so that a cam surface 68 of the release lever 48 translates motion to the catch 50 causing the catch 50 to rotate in a clockwise direction around first pivot axis a and the lever arm 42 disengages the appendage 46 of the release lever 48. This occurs when the ring gear 30 is not translating opposing motion to release lever 48. Simultaneously, the U-shaped channel 54 receives the striker 56 causing the catch 50 to rotate in a clockwise direction around first pivot axis a so that the striker 56 is securely engaged within the U-shaped channel 54 defined by the catch 50. In this orientation, the catch 50 is no longer engaged with the indicator member 58 allowing the indicator member 58 to also pivot in a clockwise direction as it is biased to do by an indicator biasing element 82.

The catch 50 also defines an intermediate stop 70 that engages the striker 56 when the vehicle door 12 is disposed in an ajar position. Therefore, the catch 50 rotates only partially in the clockwise direction around pivot axis a into an intermediate position. Simultaneously, the indicator member 58 also only partially rotates in a clockwise direction around pivot axis b so that the indicator member 58 is also disposed in an intermediate position. It should be obvious to those of ordinary skill in the art that the catch 50 and the indicator member 58 include three defined positions, latched, wherein the vehicle door 12, 18 is closed and the U-shaped channel engages the striker 56; intermediate, wherein the vehicle door 12, 18 is ajar and the intermediate stop 70 engages the striker 56; and fully open, wherein the vehicle door 12, 18 is open and the catch assembly 22 is fully separate from the striker 56.

A latched indicator 72A, an intermediate (ajar) indicator 72B, and an unlatched detector are disposed upon a proximate surface 74 of the indicator member 58. In this embodiment, each indicator 72A-C is contemplated to be a magnet. However, it should be understood by those of ordinary skill in the art that other types of indicators capable of transmitting a signal identifying a location of each indicator 72A-C is within the scope of this invention.

As best represented in FIG. 6, a plurality of detectors 76A-C is disposed upon a bottom wall 78 of the printed circuit board 62. A latched detector 76A cooperates with the latched indicator 72A. An intermediate detector 76B cooperates with the intermediate indicator 76B. An unlatched detector 76C cooperates with the unlatched indicator 72C. It is contemplated by the inventors that the detectors 76A-C are Hall affect sensors capable of detecting proximity of a magnetic force generated by the magnetic indicator 72. However, it should be understood by those of ordinary skill in the art that alternative detectors 76A-C capable of identifying proximity of the indicators 72A-C are included within the scope of this application.

Each indicator 72A-C disposed upon the proximate surface 74 of the indicator member 58 stops at its corresponding detector 76A, 76B, 76C enabling each of the detectors 76A, 76B, 76C to identify the disposition of the indicator member 58, which in turn identifies the disposition of the catch 50. Therefore, the detectors 76A, 76B, 76C translate a proximity signal via the printed circuit board 62 to the engine control module (not shown) providing a signal to a vehicle occupant as to the disposition of a given vehicle door 12, 18. As such, this simplified device provides a self-contained method of identifying a disposition of a vehicle door without requiring separate and redundant wiring to an indicator switch.

When the vehicle door 12, 18 is fully closed, the catch biasing element 80 biases the catch 50 to securely engage the striker 56 securely closing the vehicle door 12, 18. In this orientation, the catch 50 disengages the indicator member 15 allowing the indicator biasing element 82 to pivot the indicator member 58 around axis b so that the latched indicator 72A is disposed proximate the latched detector 76A. Upon detecting the latched indicator 72A, the latched detector 76A signals the vehicle controller the vehicle door 12, 18 is closed.

When the vehicle door 12, 18 is partially closed or ajar, the catch 50 is partially pivoted around axis a in an opposite direction to the bias of the catch by the striker 56 resulting in the catch 50 partially engaging the indicator member 15. Thus, the catch 50 partially rotates the indicator member 58 locating the intermediate indicator 72B proximate the intermediate detector 76B. Upon detecting the intermediate indicator 72B, the intermediate detector 76B signals the vehicle controller the vehicle door 12, 18 is ajar.

When the vehicle door 12, 18 is fully open, the electric motor 24 has translated rotational motion to the catch 50 in a manner set forth above to cause the catch 50 to fully pivot around the axis a in a direction opposite to the catch 50 bias. The catch 50 fully engages the indicator member 58 fully rotating the indicator member 58 in a direction opposite to the bias provided to the indicator member 58 by the indicator biasing member 82. In this disposition, the unlatched indicator 72C is located proximate the unlatched detector 76C causing the unlatched detector 76C to signal the vehicle controller the vehicle door 12, 18 is fully open.

Including a plurality of spaced indicators 72A-C allows for sufficient spacing of the detectors 76A-C around second pivot axis b. This spacing prevents magnetic force of a non-correlated indicator, such as, for example, the latched indicator 72A or the intermediate indicator 72B being detected by the unlatched detector 72C without requiring unnecessary amount of rotation of the indicator member 58 around the second pivot axis b.

The invention has been described in an illustrative manner, and it is to be understood the terminology that has been used is intended to be in the nature of words of description rather than of limitation. Obviously, many modifications and variations of the present invention are possible in light of the above teachings. It is therefore to be understood that within this specification, the reference numerals are merely for convenience, and are not to be in any way limiting, so that the invention may be practiced otherwise than is specifically described.

What is claimed is:

1. An electronic latch assembly for securing a vehicle door to a vehicle frame, comprising:
a striker fixedly attached to the vehicle frame;
a catch assembly fixedly attached to the vehicle door for securing the vehicle door to the vehicle frame when the vehicle door is disposed in a closed position;
said catch assembly including a catch pivotally affixed to a mount at a first pivot axis in an orientation enabling engagement and disengagement of said catch with said striker, said catch being pivotable between a latched disposition and an unlatched disposition;
an indicator member cooperably affixed to said mount with said catch; said catch translating movement to said indicator member when said catch pivots around said first pivot axis between the latched disposition and the unlatched disposition; and
said indicator member including in indicator for indicating a disposition of said catch between the latched disposition and the unlatched disposition relative to said striker.

2. The assembly set forth in claim 1, wherein said indicator member is pivotally affixed to said mount at a second pivot axis and said indicator comprises a plurality of magnets.

3. The assembly set forth in claim 2, wherein said catch assembly includes a detector for detecting proximity of said indicator relative to said detector.

4. The assembly set forth in claim 3, wherein said detector comprises first and second hall affect sensors separately located to distinguish between said catch being disposed in the latched disposition and the unlatched disposition when detecting proximity one of said magnets.

5. The assembly set forth in claim 4, wherein said detector comprises a third hall affect sensor separately located from said first and said second hall affect sensor to detect one of said plurality magnet when said catch is disposed in an intermediate disposition.

6. The assembly set forth in claim 1, wherein said catch assembly includes an electric motor for actuating said catch between the latched position and the unlatched position relative to said striker.

7. The assembly set forth in claim 2, wherein said indicator member is biased toward the unlatched disposition and the catch is biased toward the latched disposition.

8. The assembly set forth in claim 5, wherein catch assembly includes a printed circuit board and said first, second and third hall affect sensors are disposed upon said printed circuit board.

9. The assembly set forth in claim 8, wherein said catch assembly includes a release lever receiving motion from an electrical motor for moving said catch from said latched disposition toward said unlatched disposition.

10. The assembly set forth in claim 6, wherein said electric motor counteracts a bias of said catch toward said latched disposition and translates motion to said indicator member through said catch.

11. An electronic latch assembly for securing a vehicle door to a vehicle frame, comprising:
a latch assembly affixed to the vehicle door and a striker affixed to the vehicle frame, said latch assembly including a catch assembly presenting an engagement element for engaging said striker thereby securing the vehicle door in a closed position;
said catch assembly including a latched disposition, an unlatched disposition, and intermediate disposition relative to said striker;
an electric motor for actuating said catch when an intent to disengage said catch from said striker is detected; and
an indicator member being engagable with said catch assembly, with said catch assembly translating movement to said indicator member and said indicator member signaling a disposition of said catch assembly between the latched disposition, the unlatched disposition and the intermediate disposition.

12. The assembly set forth in claim 11, wherein said catch assembly includes a biasing element for biasing said catch assembly toward the latched disposition and said electric motor counteracts said biasing member for moving said catch assembly toward said unlatched disposition.

13. The assembly set forth in claim 11, wherein said indicator member includes an indicator and said indicator signals a detector assembly a location of said indicator.

14. The assembly set forth in claim 13, wherein said detector assembly includes a latched detector, an unlatched detector and an intermediate detector, each of said detectors detecting proximity of a corresponding indicator for identifying the disposition of said catch assembly.

15. The assembly set forth in claim 11, further including a printed circuit board with said detector being integral with said printed circuit board.

16. The assembly set forth in claim 11, wherein said indicator includes an indicator biasing element for biasing said indicator to indicate an unlatched disposition.

17. The assembly set forth in claim 16, wherein said catch assembly counteracts said indicator biasing element when said catch assembly includes said latched disposition and said intermediate disposition.

18. The assembly set forth in claim 11, wherein said indicator member includes a magnet and said magnet signals a detector assembly a location of said indicator.

19. The assembly set forth in claim 13, wherein said detector comprises a plurality of Hall affect sensors including a latched Hall affect sensor, an unlatched Hall affect sensor and an intermediate Hall affect sensor, each of said Hall affect sensors detecting proximity of said indicator for identifying the disposition of the catch assembly.

20. The assembly set forth in claim 11, wherein said electric motor counteracts a bias of said catch toward said latched disposition and translates motion to said indicator member through said catch.
